(19) United States
(12) Patent Application Publication
(10) Pub. No.: US 2026/0134133 A1
(43) Pub. Date: May 14, 2026

(54) Enhanced Role-Based Access Control For Cross-Namespace References In Compute Clusters

(71) Applicant: NetApp, Inc., San Jose, CA (US)

(72) Inventors: Ashwin Palani, Apex, NC (US); Prabh Simran Singh, Fremont, CA (US); Joseph Ray Thomas, III, Arvada, CO (US); Nathan Daniel Hammernik, Erie, CO (US); Alexander George Karlis, San Jose, CA (US)

(21) Appl. No.: 19/383,010

(22) Filed: Nov. 7, 2025

Related U.S. Application Data
(60) Provisional application No. 63/718,144, filed on Nov. 8, 2024.

(51) Int. Cl. G06F 21/62; G06F 11/14; H04L 9/40

(52) U.S. Cl. CPC G06F 21/6218; G06F 11/1469; H04L 63/105; G06F 2201/805

(57) ABSTRACT

The disclosure describes a system for enforcing role-based access control in a multi-tenant compute cluster with cross-namespace references. A control plane of the compute cluster receives a custom-resource request from a tenant to create or modify a first custom resource in a tenant namespace. The first custom resource references if a second custom resource in an administrative namespace. In response to the request, the control plane transmits a validating admission request to a data-protection controller registered as a webhook endpoint for admission validation. The data-protection controller retrieves access metadata from the referenced second custom resource and generates an admission determination indicating whether the tenant's request satisfies cross-namespace access conditions defined in the metadata. The controller returns the admission determination to the control plane, which admits or denies the custom-resource request accordingly.

### CROSS-REFERENCE TO RELATED APPLICATIONS

This application claims priority to U.S. Provisional Ser. No. 63/718,144 titled “ENHANCED ROLE-BASED ACCESS CONTROL FOR CROSS-NAMESPACE REFERENCES IN COMPUTE CLUSTERS,” filed Nov. 8, 2024, the contents of which are incorporated by reference in its entirety for all purposes.

### BACKGROUND

Orchestration platforms such as Kubernetes support the creation of custom resources to extend native functionality and enable tailored application workflows. While these platforms provide Role-Based Access Control (RBAC) to manage permissions for native resources, the built-in RBAC capabilities may be insufficient for scenarios involving custom resources, particularly when cross-namespace references are involved.

For example, when a custom resource in one namespace references another custom resource or shared resource in a different namespace, native RBAC mechanisms focus primarily on managing access within individual namespaces and do not enforce or validate cross-namespace references. This limitation can lead to security gaps, where unauthorized users could potentially create or modify custom resources that reference protected resources in other namespaces, bypassing intended access controls and compromising data isolation. The lack of cross-namespace validation in native RBAC poses significant challenges in multi-tenant environments, where different teams or users need controlled and secure access to shared resources without overexposing sensitive configurations.

### SUMMARY

The disclosure describes a system to enhance role-based access control for compute clusters. A control plane in the compute cluster receives a custom-resource request from a tenant to create or modify a first custom resource in a tenant namespace. The first custom resource includes a reference to a second custom resource in an administrative namespace. The control plane then transmits a validating admission request to a data-protection controller registered with the control plane for admission validation. The data protection controller retrieves access metadata defined in the second custom resource. The data protection controller generates an admission determination indicating whether the custom-resource request is permitted. The data protection controller provides the admission determination to the control plane, thus providing for access enforcement across namespaces at a time of creation for custom-resources, alleviating the above-described issues.

These and other features and aspects of various examples may be understood in view of the following detailed discussion and accompanying drawings.

### BRIEF DESCRIPTION OF THE DRAWINGS

FIG. 1 illustrates an example of various components that may be present in a computing environment in an implementation.

FIG. 2 illustrates an example of a set of operations that may be used in an access control process in an implementation.

FIG. 3 illustrates an example of various components that may be present in a namespace scenario in an implementation.

FIG. 4 illustrates an example of various components that may be present in another namespace scenario in an implementation.

FIG. 5 illustrates an operational sequence illustrating an example of a set of communications between various components that may occur in accordance with an implementation.

FIG. 6 illustrates an example of a set of operations that may be used in an application restore process in an implementation.

FIG. 7 illustrates an example of various components that may be present in a compute cluster in an implementation.

FIG. 8 illustrates a computing system suitable for implementing the various operational environments, architectures, environments, processes, scenarios, sequences, and frameworks discussed below with respect to the other Figures.

### DETAILED DESCRIPTION

Orchestration platforms such as Kubernetes manage resources in logical groupings called namespaces to provide resource isolation and access control across multiple tenants. In these environments, an access control framework such as Role-Based Access Control (RBAC) determines which users or service accounts are permitted to perform specific operations on platform resources. RBAC policies are typically evaluated by the control plane of the orchestration platform, which authorizes or denies operations (e.g., requests to create pods or nodes) based on user credentials, assigned roles, and associated permissions. In a typical orchestration platform, resources managed by the control plane include native resources, such as pods and nodes, that define or support execution of containerized workloads. These native resources are generally scoped to a single namespace or cluster context and are not configured to reference resources located in other namespaces. Accordingly, the native authorization mechanisms evaluate access rights only on a per-resource and per-namespace basis.

This limitation poses challenges in environments where custom resources are used, particularly when such resources reference other resources across namespace boundaries. These custom resources may be associated with specialized workflows, such as application backup, restore, replication, or snapshot creation, and may include reference fields identifying other resources within the cluster. For example, a custom resource in an “engineering” namespace may reference secured storage resources residing in an administrative namespace. Because standard RBAC evaluation is applied only to the resource being created or modified, the control plane is unable to natively determine whether a tenant user in one namespace is authorized to reference or operate on a protected resource in another.

As a result, these cross-namespace references may introduce significant security gaps in multi-tenant environments. In a typical deployment, an orchestration platform may host workloads for multiple organizational groups or tenants, such as an engineering team and a marketing team, each operating within its own namespace or namespaces. In the absence of cross-namespace access validation, a tenant in one namespace may inadvertently or maliciously reference a storage vault or configuration resource belonging to another tenant or to the administrative domain. Conversely, overly restrictive global policies may block legitimate tenant operations, preventing tenants from performing valid backup or restore actions on their own applications.

The disclosure describes a system for enforcing role-based authorization across namespace boundaries within an orchestration platform. The system can leverage webhook configurations, where certain requests to create or modify custom resources (in particular custom resources with cross-namespace references such as backups) are intercepted and transmitted to a data protection controller, via the webhook, for external analysis. The controller can then evaluate each custom-resource request in real time and transmits an admission determination back to the control plane either allowing or denying the request.

In one implementation, the control plane of the orchestration platform includes an application programming interface (API) server or equivalent component configured to receive custom-resource requests from tenant users or service accounts. The custom-resource requests may specify creation or modification of custom resources within the tenant's namespace, such as backup or restore resources that reference other resources defined in an administrative namespace. Upon receiving such a request, the control plane initiates a validation sequence by transmitting a validating admission request to a data-protection controller registered with the control plane as a webhook endpoint. The validating admission request includes identity attributes associated with the requesting tenant, such as service account identifiers, group memberships, or other identity attributes, along with the specification of the custom resource being created or modified.

Upon receiving the validating admission request, the data-protection controller performs an evaluation sequence to determine whether the tenant's request satisfies cross-namespace access conditions defined for the referenced resource. In particular, the controller retrieves access metadata from the referenced custom resource residing in the administrative namespace. The access metadata may include role-based access descriptors, namespace identifiers, tenant identifiers, or other declarative policy data defining which roles, namespaces, or tenants are permitted to reference the resource. The controller may determine the requesting tenant's roles based on these identifying attributes and compare these roles to the access metadata to determine if the operation is allowed.

Unlike conventional admission controllers that statically enforce cluster-wide policies, the disclosed system performs application-scoped validation, that is, validation contextualized to the specific application and its associated namespaces. This enables dynamic enforcement of access rules across multiple namespaces participating in a common application or data-protection workflow. For example, a backup custom resource defined in an engineering namespace may reference a secured storage resource (e.g., an AppVault) defined in an administrative namespace. The controller provides that only tenants authorized for that secured storage resource can create such references.

After performing the access evaluation, the data-protection controller generates an admission determination indicating whether the tenant's custom-resource request is permitted. In response, the controller transmits the determination back to the control plane via the validating webhook interface. If the determination grants admission, the control plane proceeds with the requested creation or modification of the custom resource. Conversely, if the determination denies admission, the control plane rejects the request and prevents the custom resource from being created, providing that no unauthorized cross-namespace references are established. In some implementations, the admission decision is cached by the data-protection controller for subsequent validations of similar requests, reducing latency and minimizing redundant role-resolution operations during data-protection workflows, thus enhancing computing efficiency of the system (e.g., reducing processing power used for validation).

The admission process thus provides real-time, namespace-aware access enforcement at the point of resource creation. By intercepting and validating these requests prior to persistence, the system maintains tenant isolation in coordination with native control plane authorization logic. This architecture enables secure and dynamic enforcement of cross-namespace, application-scoped RBAC policies in multi-tenant environments, preventing tenants from different groups (such as “Engineering” and “Marketing”) from inadvertently referencing or accessing one another's secured storage configurations, while still allowing controlled reuse of shared administrative resources when authorized.

In one implementation, upon admission of a backup custom resource, the data-protection controller initiates a backup workflow that captures application data, metadata, and associated persistent volumes from the tenant namespace and stores the resulting backup objects in a secured storage unit, such as a bucket or repository defined by the referenced administrative custom resource. During this operation, the controller may generate encrypted metadata that includes identity attributes of the tenants or service accounts authorized to perform subsequent restore operations. The encrypted metadata is stored in association with the backup objects to provide that any later restoration attempts are subject to identity-aware validation.

During restore operations, including cross-cluster restores, the encrypted metadata provides an additional layer of access control. For example, a second compute cluster (e.g., a remote cluster), when attempting to restore the backup, decrypts the stored metadata to obtain the authorized tenant or user attributes. The data-protection controller in the second cluster compares the current requesting tenant's identity attributes with the decrypted authorization data to determine whether the restore should proceed. This provides that backups created in one cluster cannot be restored by unauthorized users or tenants in another cluster, thereby enforcing cross-cluster data-protection security. In some implementations, restore operations may further validate that the requester possesses update permissions for existing application resources, preventing unauthorized or destructive in-place restores of running applications.

The present disclosure introduces a dynamic, integrated mechanism for cross-namespace authorization that overcomes the limitations of existing systems, which provide authorization enforcement only within individual namespaces. In various embodiments, the system provides: (1) dynamic, cross-namespace role validation at admission time, enabling per-reference authorization before a resource is persisted; (2) real-time role resolution using the platform's native authorization APIs (such as Kubernetes'SubjectAccessReview), providing that access decisions reflect a tenant's current permissions; (3) declarative access descriptors embedded directly within administrative custom resources, allowing metadata-driven enforcement that remains self-contained and auditable; (4) fail-closed admission behavior that automatically denies unvalidated requests during controller or network failure, preserving cluster integrity; (5) application-scoped RBAC enforcement, aligning authorization decisions to multi-namespace application boundaries rather than isolated namespaces; (6) cross-cluster restore validation through the use of encrypted metadata defining authorized tenants or LDAP groups; and (7) comprehensive audit and logging for traceability of both admitted and denied operations. Together, these improvements enable secure, real-time access control tightly integrated with the orchestration platform's native control plane.

Various embodiments of the present technology provide for a wide range of technical effects, advantages, and/or improvements to computing systems and components. For example, various embodiments may include one or more of the following technical effects, advantages, and/or improvements: 1) a non-routine and unconventional dynamic implementation of cross-namespace, application-scoped access control within an orchestration platform, allowing authorization decisions to be evaluated in real time; 2) non-routine and unconventional operations for reference-based authorization validation in which a data protection controller evaluates access conditions defined in a referenced administrative custom resource; 3) dynamic generation of access determinations through real-time role-resolution procedures, wherein the controller determines a requester's effective roles and compare those roles to declaratively defined access descriptors in the referenced custom resource; 4) non-routine and unconventional use of encrypted identity metadata to enforce cross-cluster data-protection security, enabling a second cluster to validate restore operations based on decrypted tenant attributes; 5) distributed orchestration of multi-namespace RBAC enforcement across data-protection workflows, allowing runtime coordination between a control plane and a data-protection controller to prevent unauthorized cross-tenant references; and 6) non-routine enforcement of in-place restore permissions, including the validation of access to live application resources before allowing modification of running workloads, thereby preventing destructive restore operations that could compromise tenant applications or shared cluster resources.

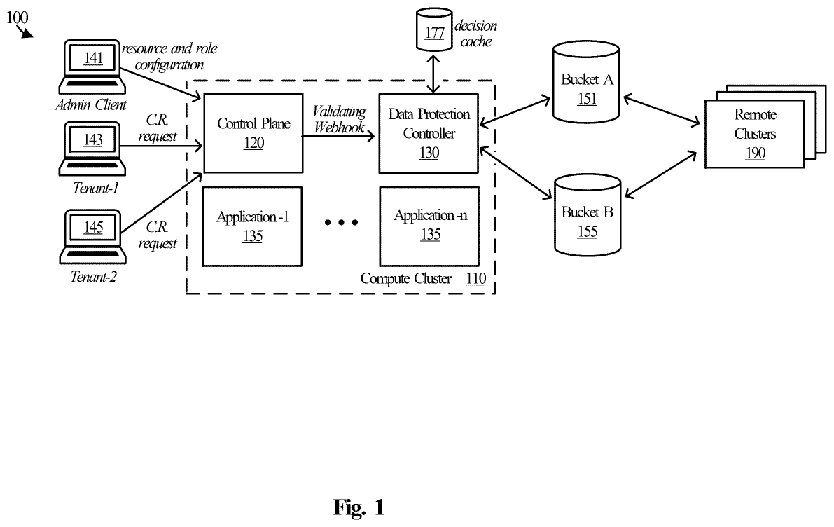

FIG. 1 illustrates compute environment 100 according to some embodiments. Compute environment 100 includes admin client 141, first tenant 143, second tenant 145, compute cluster 110, first bucket 151, second bucket 155, and remote clusters 190. While specific elements of compute environment 100 are shown for ease of description, compute environment 100 may include more or fewer of each described component as well as other components not described for simplicity.

Compute cluster 110 includes control plane 120, data protection controller 130, and applications 135. Compute cluster 110 may be a Kubernetes cluster in some implementations. However, it is noted that the concepts described herein are not limited to Kubernetes, and may be applied to other orchestration platforms.

Data protection controller 130 represents a controller within compute cluster 110 configured to execute data protection processes such as backing up applications 135, restoring applications 135, and validating tenant requests. Data protection controller 130 may, for example, run as a containerized application in a pod within compute cluster 110. Data protection controller 130 is registered with control plane 120 as a webhook endpoint configured to receive validating webhook requests from control plane 120. Control plane 120 is configured to trigger the webhook based on custom-resource requests for creation or modification of custom resources (in particular, custom resources that include cross-namespace references such as backup custom resources, restore custom resources, or snapshot creation custom resources).

Custom resources represent extensible objects defined through Custom Resource Definitions (CRDs) that extend the native resource model of the orchestration platform. Each custom resource allows administrators or tenants to define and manage domain-specific operations beyond the built-in objects such as pods and nodes. In the context of compute cluster 110, the data-protection framework introduces several custom resources, including but not limited to Backup, Restore, Replication, Snapshot, and AppVault resources. Each of these resources defines configuration parameters for data-protection workflows. For example, a backup custom resource may include fields identifying the target application, the backup schedule, and a reference to an AppVault custom resource specifying the secured storage location (e.g., bucket 151 or 155) in which the backup data will be stored.

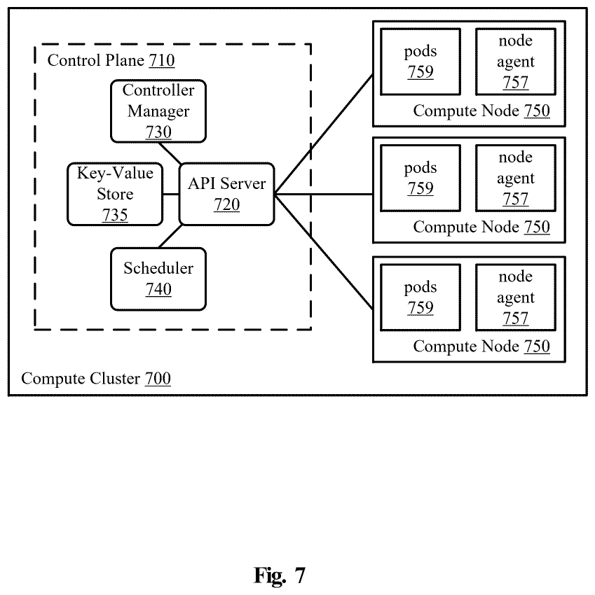

When a tenant or administrator creates one of these custom resources, control plane 120, such as a Kubernetes API server, persists the resource definition in a key-value store (e.g., key-value store 735 of FIG. 7). This store maintains the authoritative state of all cluster resources, including both native and custom resources, providing that the resources are discoverable through API queries. Each custom resource can be represented as a serialized record that includes metadata (e.g., namespace, labels, annotations, creation timestamps), specification fields defining intended behavior, and status fields updated by the corresponding controller as operations progress. Because these custom resources are managed through the same API mechanisms as native resources, the custom resources participate in role-based access control and admission workflows orchestrated by control plane 120. For example, certain administrative custom resources such as AppVaults may themselves include access metadata that defines which tenants, roles, or namespaces are permitted to reference them. This embedded access metadata extends RBAC semantics into the resource definition itself, allowing the data-protection controller to evaluate authorization at admission time based on declarative role descriptors stored with the custom resource, rather than relying solely on external policy bindings.

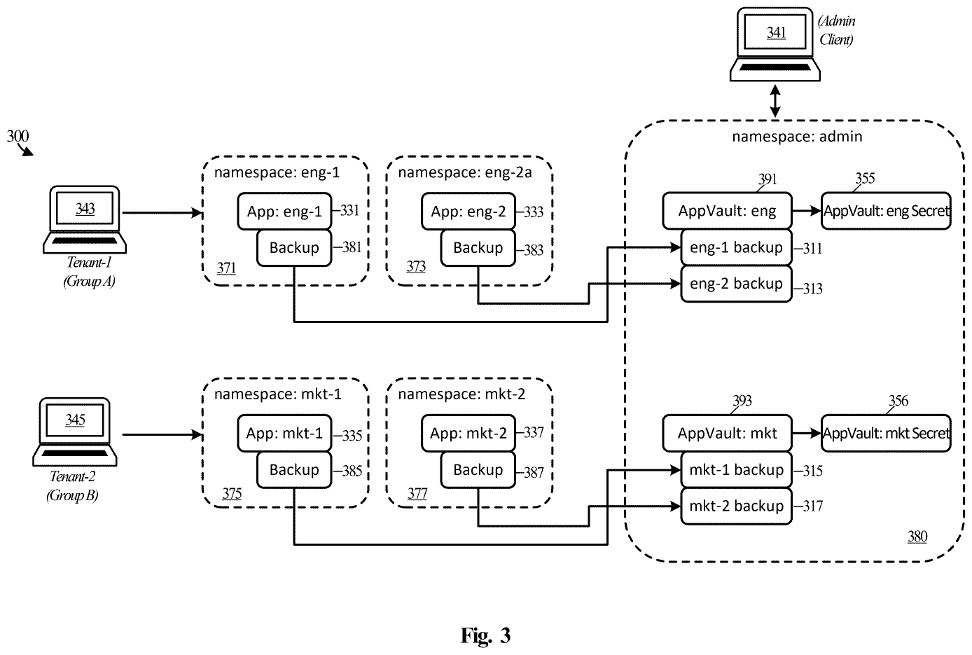

Custom resources defined by tenants may include reference fields that identify other resources within the cluster by name, type, and namespace. For example, a backup custom resource (see, e.g., backup resource 381 of FIG. 3) created in a tenant namespace (e.g., namespace 371 of FIG. 3) may contain a reference field (such as spec. appVaultRef) that points to an AppVault custom resource residing in an administrative namespace (e.g., resource 391 namespace 380 of FIG. 3). This cross-namespace reference allows a tenant to initiate a backup operation that stores data in a centrally managed secure storage unit (e.g., bucket 151 or 155). During creation of such a resource, control plane 120 invokes the validating webhook registered for data-protection controller 130.

When invoked via the webhook, data protection controller 130 may perform validation for various workflows, including application backup workflows and application restoration workflows, among other operations. In an application backup workflow, data protection controller 130 may validate a tenant request to create a backup resource, providing for the backup of an application 135 to the designated bucket (e.g., bucket 151 or 155). In an application restoration workflow, data protection controller 130 may validate a tenant request to restore an application 135 from one of the designated buckets 151, 155, to determine whether the tenant has the appropriate permissions to access the backup data stored in bucket 151 or 155.

In some implementations, data protection controller 130 includes decision cache 177, which represents a repository storing previous validation results generated by the validating webhook. Decision cache 177 enables the system to reuse prior admission decisions for repeated or similar requests, thereby improving performance and reducing latency for high-frequency operations such as recurring backups. For example, if a tenant repeatedly creates backup custom resources that reference the same AppVault and access context, data protection controller 130 may retrieve a cached “allow” or “deny” determination from decision cache 177 instead of re-evaluating all role bindings and policy descriptors.

Control plane 120 represents an orchestration platform that manages and coordinates the resources within compute cluster 110. In various implementations, control plane 120 may be a Kubernetes control plane, though the concepts described herein are not limited to Kubernetes and may be applied to other orchestration or container-management platforms that employ declarative configuration and admission control. Control plane 120 may include one or more components such as an API server, scheduler, controller manager, and key-value store, as illustrated for example in FIG. 7.

An API server of control plane 120 (see, e.g., API server 720 of FIG. 7) serves as the primary interface for cluster interactions, receiving and validating requests from admin client 141, tenants 143 and 145, data-protection controller 130, and other components. The API server handles authentication, authorization, and admission control, providing that only properly authenticated and authorized operations are admitted into the cluster state. In some implementations, the API server communicates with a data store (for example, a key-value store) that holds all resource definitions, including native objects and custom resources such as “AppVault,” “Backup,” “Restore,” and “Snapshot” objects, defined by admin client 141 or by tenants 143 and 145 within their respective namespaces.

In certain embodiments, control plane 120 is further configured with a fail-closed admission policy to provide secure behavior during outages of data protection controller 130 or communication failures. Under this policy, if the data-protection controller 130 or any registered validating webhook endpoint becomes unavailable or fails to respond within a defined timeout period, control plane 120 automatically denies any custom-resource requests that would otherwise require external validation. This fail-closed configuration prevents unauthorized or unverified resource creation from proceeding in the absence of external admission checks, thereby maintaining the integrity and security posture of the cluster. The policy may be enforced at the level of the API server's admission controller configuration, which marks webhook-validated resources as “required” such that failures to reach the external validation service result in a rejection rather than an implicit approval.

Admin client 141 may configure validating webhooks within control plane 120 to augment the role-based access control functionality in compute cluster 110. These validating webhooks can be set to trigger upon certain requests from tenants 143 and 145, such as a request to create or modify a custom resource (e.g., a backup resource or a restoration resource) that references another custom resource in a different namespace (e.g., an AppVault). Control plane 120 routes the validating webhook request to data protection controller 130, which evaluates the request and responds with either an approval or denial. If control plane 120 receives approval, control plane 120 proceeds to execute the user request (e.g., creating or modifying the new backup resource or a restoration resource). Conversely, if control plane 120 receives a denial, control plane 120 rejects the user request, including, for example, providing an error message to the requesting tenant 143 or 145.

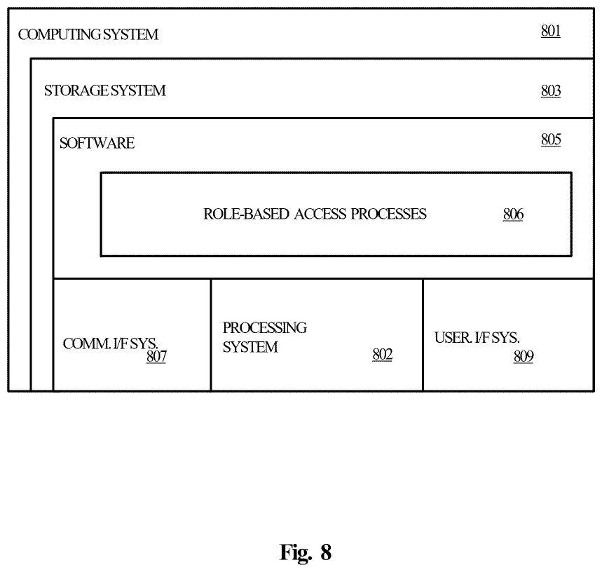

Admin client 141 is representative of a device (e.g., computing system 801 of FIG. 8) hosting a user or application with administrative privileges in compute cluster 110. Admin client 141 may access control plane 120 via an API server. Admin client 141 may have access to all namespaces within compute cluster 110, including an administrative namespace (e.g., “admin” namespace 380 of FIG. 3) and application-level namespaces (e.g., namespaces 371, 373, 375, and 377 of FIG. 3). Accordingly, admin client 141 may have permissions to perform various operations (e.g., “create,” “delete,” and “get”) for resources in each of these namespaces.

Admin client 141 is responsible for defining and creating custom resources, which extend the functionality of an orchestration platform such as Kubernetes (represented by control plane 120 in FIG. 1). Custom resources are user-defined resource types that allow developers and operators to introduce new abstractions tailored to their workflows. By implementing custom resources, administrators can define complex operations and automate tasks that are not natively supported by orchestration platforms such as Kubernetes. For example, in a data protection environment several custom resources play a role in orchestrating backup and data protection operations. These resources may include backup custom resources that outline the configuration and scope of backup tasks, and AppVault custom resources that define the storage locations and credentials for backing up applications 135.

As illustrated in FIG. 3, the backup custom resources are created within the application-level namespaces (i.e., namespaces 371, 373, 375, 377 of FIG. 3) to specify backup operations tied to tenant applications, while the AppVault custom resources reside in the administrative namespace (i.e., namespace 380 of FIG. 3) to centralize the control and management of secure storage configurations. The AppVault custom resources can include metadata set by the administrator to define access privileges, specifying which user groups, such as engineering users or marketing users, are authorized to reference them. It is noted that the specific custom resources and namespaces illustrated in FIG. 3 are exemplary, and that the role-based access control procedures described herein may be applied to various types of custom resources and namespaces.

Admin client 141 is also responsible for creating user accounts for other tenants (e.g., first tenant 143 and second tenant 145) and assigning appropriate roles to these tenants. Specifically, admin client 141 may submit role bindings to control plane 120 to grant tenants 143 and 145 the permissions to access certain namespaces. A role binding associates a defined role (with specific permissions) to a user (e.g., tenants 143, 145) or service account within a designated namespace. For instance, if first tenant 143 is part of the engineering department within an organization, admin client 141 may create and apply role binding that grants first tenant 143 access to specific namespaces containing engineering applications (e.g., namespaces 371 and 373 in FIG. 3).

Tenants 143, 145 are representative of devices (e.g., computing system 801 of FIG. 8) hosting users or applications with limited privileges in compute cluster 110 according to some implementations. Tenants 143, 145 may access control plane 120 via an API server of control plane 120. Tenants 143, 145 may have permissions for application-level namespaces but not administrative namespaces according to some implementations. In particular, first tenant 143 may have permissions for a first set of namespaces, while second tenant 145 has permissions for a second set of namespaces. For example, first tenant 143 may have a role granting access to all engineering application namespaces (e.g., namespaces 371, 373 of FIG. 3), while second tenant 145 may have a role granting access to all marketing application namespaces (e.g., namespaces 375, 377 of FIG. 3). While the “engineering and marketing” example is applicable where tenants 143, 145 are in the same organization, in some implementations, first tenant 143 and second tenant 145 may belong to different organizations that share compute cluster 110, with each tenant having permissions specific to the applications belonging to their respective organizations.

Applications 135 represent applications running in compute cluster 110. While two applications 135 are illustrated in FIG. 1 for simplicity, it is to be understood that compute cluster 110 may include any number of applications. Applications 135 may be implemented in pods within compute cluster 110 in some implementations. Admin client 141 and tenants 143, 145 may request backups of applications, for example, by submitting a request to create a backup custom resource to control plane 120. These backups may reference an AppVault custom resource, which define configuration parameters for secured storage units (e.g., for respective buckets 151, 155) and defines the secured storage units as the destination for the backup of an application. It is noted that the AppVault custom resource may reside in an administrative namespace (e.g., namespace 380 of FIG. 3) while the backup and respective application 135 may reside in the requesting tenant's namespace. Thus, absent the RBAC enhancement features described herein, a control plane 120 such as a Kubernetes control plane may allow creation of the backup regardless of whether the user has permissions for the specific AppVault within the administrative namespace. The present disclosure describes enhancement of the RBAC capabilities to control access to these AppVaults.

Buckets 151 and 155 represent data repositories, such as S3 buckets, used for storing application backup data. Data protection controller 130 manages the process of storing backups of applications 135 in buckets 151 and 155 once a backup resource is created by control plane 120. Buckets 151 and 155 may be accessible by different tenants; for instance, bucket 151 might be designated for use by engineering tenants to store backups of engineering applications, while bucket 155 could be reserved for marketing tenants to hold backups related to marketing applications.

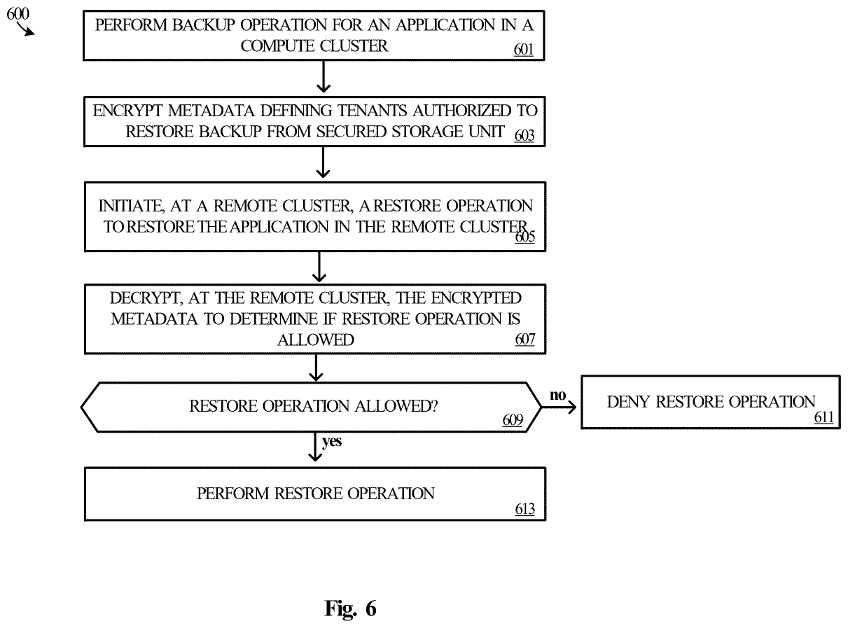

In certain implementations, compute environment 100 may further include remote clusters 190 that participate in cross-cluster data-protection workflows. Remote clusters 190 may include substantially similar components as compute cluster 110. Remote clusters 190 may, for example, be geographically distinct clusters managed by the same or different organizations that share encrypted backup data. During a cross-cluster restore operation, data protection controller 130 may perform validation using encrypted access metadata, as described further in below in relation to process 600 of FIG. 6.

The AppVault custom resource plays a role in regulating access to these buckets, providing that only authorized tenants can use the specified storage resources according to their assigned roles. For example, engineering tenants may be configured with access to bucket 151 through specific AppVault permissions that reference their roles, while marketing tenants may have access defined for bucket 155. This mechanism enforces access control, providing that data is isolated according to tenant and department and aligns with the organization's security and compliance requirements for data protection. The ability to reference specific storage resources (e.g., S3 buckets) through AppVaults helps centralize and streamline access control policies for multi-tenant environments, maintaining data integrity and secure data management.

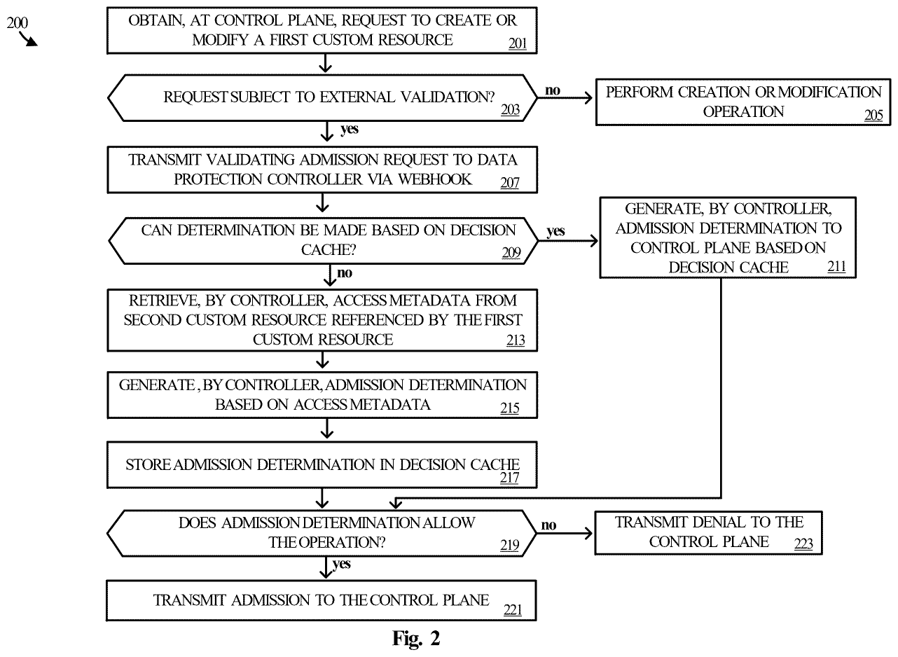

FIG. 2 illustrates an example of a process for RBAC in a compute cluster, represented by process 200. Process 200 is performed by one or more computing devices which may be represented by computing system of FIG. 8. The steps described by process 200 may be performed by components of compute environment 100, including control plane 120 and data protection controller 130. Process 200 may be implemented in program instructions (software and/or firmware) by one or more processors of the computing device(s). The program instructions direct the computing device to operate as follows, referring to the steps in FIG. 2.

In process 200, control plane 120 obtains (e.g., from tenant 143 or 145, referred to in process 200 as tenant 143 for brevity) a request to create or modify a first custom resource (step 201). The request may be submitted via an API call, command-line interface (CLI), or graphical management interface that interacts with the API server of control plane 120. The first custom resource may include, for example, a backup custom resource (initiating backup of an application 135), a restore custom resource (initiating a restore operation for application 135), or a snapshot custom resource (initiating a snapshot of application 135). The first custom resource is defined within the tenant's namespace (e.g., namespace 371 of FIG. 3) and may contain a reference to a second custom resource such as an AppVault defined in an administrative namespace (e.g., namespace 380 in FIG. 3).

Control plane 120 (e.g., an API server of control plane 120) determines if the request is subject to external validation (step 203). This determination may be based on admission control policies or webhook registration configurations previously defined by admin client 141. Specifically, admin client 141 may register validating webhooks with control plane 120 to handle admission requests that target custom resources of a particular type, such as backup, restore, or snapshot resources. When the incoming request matches the conditions defined for external validation (e.g., a creation or modification operation for a custom resource that references another namespace), control plane 120 flags the request as subject to external validation and prepares a validating admission review request for transmission to data-protection controller 130.

When control plane 120 determines that the request is not subject to external validation, control plane 120 proceeds to perform the creation or modification operation (step 205). In such cases, the operation may be handled solely through native mechanisms of the orchestration platform (for example, native Kubernetes RBAC and resource admission controls). Control plane 120 evaluates the requester's privileges according to internal role bindings and authorization rules associated with the target namespace. If the tenant possesses the necessary role permissions for the requested operation (e.g., create or update), the control plane persists the resource in the cluster data store (for example, the key-value store) and acknowledges successful completion to tenant 143. It should be noted that this creation or modification operation may still be subject to compliance with internal policies such as quota limits, label validation, or namespace-level admission rules, even if a request does not trigger external webhook validation. Conversely, if the tenant lacks appropriate internal RBAC privileges, control plane 120 may reject the request at this stage without invoking external validation.

When control plane 120 determines that the request is subject to external validation, control plane 120 transmits a validating admission request to data protection controller 130 via a webhook (step 207). The validating admission request may include one or more identity attributes associated with tenant 143. These identity attributes may include, for example, a service account identity, or a group membership. The validating admission request may further include the specification of the first custom resource, including reference fields that identify other resources (for example, a second custom resource such as an AppVault in another namespace). Control plane 120 may also apply a fail-closed policy such that, if data protection controller 130 is unavailable or a webhook call times out, the control plane automatically denies the request to preserve cluster security integrity.

Upon receiving the validating admission request, data protection controller 130 determines whether an admission decision can be made based on information stored in a decision cache 177 (step 209). The decision cache 177 maintains a record of recent admission results keyed to parameters such as the requester's identity, the type of operation (for example, creation or modification), the kind of custom resource, the namespace, the referenced resource name, and the version of any relevant access metadata. If a matching entry is found, data protection controller 130 retrieves the cached decision and generates the corresponding admission determination (step 211), granting or denying the request based on corresponding results in the matching entry, thereby avoiding a full re-computation of access validation.

If data-protection controller 130 determines that no valid cache entry exists, controller 130 proceeds to retrieve access metadata from the second custom resource (e.g., an AppVault) referenced by the first custom resource (step 213). The access metadata may include role-based access descriptors, authorized service accounts, group identifiers, tenant identifiers, and/or policy annotations defining which entities are permitted to reference the second custom resource. Upon retrieving this metadata, controller 130 initiates a role-resolution operation, which determines the tenant's effective permissions within the cluster. In this context, role resolution refers to issuing a query to control plane 120 (e.g., a Kubernetes SubjectAccessReview (SAR)) for the tenant's current roles, groups, and namespace-level privileges, based on the identity attributes carried in the validating admission request. The operation thus translates raw identity attributes (e.g., service account name, user ID, or group) into the live RBAC roles recognized by control plane 120.

Data-protection controller 130 then generates an admission determination based on the correlation between the requester's resolved roles and the access metadata defined in the referenced custom resource (step 215). The admission determination may either “allow” or “deny” the creation or modification of the custom resource. This determination process may proceed along one or more validation paths depending on the metadata schema. In a role-based configuration, controller 130 compares the requester's effective roles against the list of authorized roles specified in the access metadata. In a group-based configuration, the comparison may involve matching the tenant's group membership (for example, engineering or marketing) to the set of groups enumerated in the access metadata. In a service-account configuration, the controller may directly compare the service-account identifier in the admission request with the list of accounts allowed to reference the vault.

For example, suppose tenant 143 submits a backup custom-resource request in an engineering namespace that references an AppVault custom resource in administrative namespace. The validating admission request forwarded by control plane 120 includes the tenant's identity attributes (e.g., a service account name or a group identifier). Controller 130 performs a role-resolution operation and determines that this identity resolves to the roles eng-backup-operator. The AppVault's access metadata lists “eng-backup-operator” as an authorized role. Controller 130 therefore generates an allow admission determination and caches the result. Conversely, if a requester's resolved roles do not appear in the authorized role list, or if the metadata imposes additional namespace or group constraints that are not met, controller 130 generates a deny determination.

In some implementations, the first custom resource may be a restore custom resource that specifies the restoration of an application 135 in compute cluster 110. In such cases, data-protection controller 130 performs additional validation beyond the cross-namespace access check. Specifically, controller 130 determines whether the requesting tenant possesses sufficient permissions, such as update privileges, on an application custom resource associated with the application being restored. Because restoration typically involves overwriting or modifying the state of an existing application, this additional authorization layer provides that the tenant is permitted not only to reference the secured storage unit (e.g., an AppVault) but also to alter the target application's configuration or state. To perform this validation, controller 130 may query the control plane's role and permission definitions (e.g., through a SubjectAccessReview API call) to confirm that the tenant's effective permissions include the ability to update or modify the specific application resource identified in the restore request. Only when both the reference-based authorization and update permission checks are satisfied does controller 130 issue an admission determination approving the restore operation.

After generating the determination, controller 130 stores the resulting determination in decision cache 177 (step 217). Decision cache 177 may include, for example, a record of the requesting tenant's identity attributes, associated roles, referenced custom resource identifier, and the access metadata used in the evaluation. In some implementations, decision cache 177 may also record the decision outcome (e.g., “allow” or “deny”) along with a time-to-live (TTL) value defining how long the cached result remains valid. Accordingly, data protection controller 130 may use the determination for subsequent similar requests (e.g., as described with respect to step 209).

Decision step 219 illustrates different steps taken by data protection controller 130 based on the admission determination of step 215 or step 211. If the admission determination indicates an approval (e.g., indicating “allow”), controller 130 transmits an allow decision to control plane 120 (step 221). Conversely, if the cached entry indicates a denial (e.g., indicating “deny”) controller 130 transmits a denial response to control plane 120 (step 223). Control plane 120 rejects denied requests and may log each event with identifying information such as tenant identifiers, namespaces, and referenced resources. When an allow decision is received, control plane 120 admits and persists the first custom resource in the cluster's data store (for example, the key-value), thereby completing the creation or modification operation.

Through these operations, process 200 enforces dynamic, application-scoped RBAC that extends across namespaces and clusters while maintaining secure, efficient, and auditable admission control.

FIG. 3 illustrates namespace scenario 300 according to some implementations. Namespace scenario 300 includes admin client 341, first tenant 143, second tenant 145, engineering namespaces 371 and 373, marketing namespaces 375 and 377, and administrative namespace 380. While “engineering” and “marketing” are shown in FIG. 3 for exemplary purposes, the namespaces and tenants may represent any number of departmental, project-specific, or organizational groupings in various implementations.

Admin client 341 possesses administrative privileges for all namespaces shown in FIG. 3, whereas first tenant 343 has access only to the engineering namespaces 371 and 373, and second tenant 345 has access only to the marketing namespaces 375 and 377. Each of the application-level namespaces 371, 373, 375, and 377 includes an application custom resource (App: eng-1 331, App: eng-2 333, App: mkt-1 335, App: mkt-2 337) and a corresponding backup custom resource (Backup 381, 383, 385, 387). These backup custom resources are created by the respective tenants within their authorized namespaces.

Administrative namespace 380 includes AppVault custom resources 391 and 393, which may be created and managed by admin client 341, as tenants 343 and 345 do not generally have privileges to access or create resources within administrative namespace 380. Each AppVault resource (e.g., AppVault: eng 391, AppVault: mkt 393) references a respective secret resource (AppVault: eng Secret 355, AppVault: mkt Secret 356) that stores authentication credentials and encryption information for the secured storage units used for backup operations. The engineering and marketing backup resources 381-387 each include a reference field identifying the appropriate AppVault 391 or 393, thereby specifying the storage configuration used for their backups. The “backup” entries 311, 313, 315, 317 depicted within administrative namespace 380 represent logical references or metadata fields in the tenant backup resources rather than resources themselves residing in the administrative namespace.

Admin client 341 341 may configure the metadata of AppVault resources 391 and 393 to define which tenants, roles, or identity groups are authorized to reference those AppVaults. This access metadata is evaluated by data-protection controller 130 during admission validation, as described in connection with FIGS. 1 and 2. For example, if second tenant 345 (a marketing tenant) attempts to create a backup resource that references engineering AppVault 391, the control-plane admission webhook transmits the request to data-protection controller 130, which denies the request based on the AppVault's metadata configuration. Such cross-namespace validation enforces tenant isolation, maintains data integrity, and ensures that each secured storage bucket (e.g., bucket 151 or 155 of FIG. 1) remains restricted to its authorized department or tenant group. In some implementations, the access metadata further defines specific permitted operations (e.g., backup, restore, snapshot) per tenant role, enabling fine-grained RBAC enforcement across namespaces and clusters.

Each AppVault resource (e.g., AppVault: eng 391, AppVault: mkt 393) includes a reference to a corresponding Secret resource (AppVault: eng Secret 355, AppVault: mkt Secret 356) that contains authentication credentials, access keys, or encryption data for connecting to the secured storage units. The Secrets resource may be accessible only to privileged components (e.g., data-protection controller 130) within the administrative namespace 380. The Secret resources 355 and 356 may be leveraged during backup and restore operations to provide secure access credentials for the corresponding storage units.

During a backup operation, data-protection controller 130 retrieves the referenced Secret for the selected AppVault 391 or 393 to obtain encrypted credentials and establish a secure session with the associated storage bucket (e.g., bucket 151 or 155 of FIG. 1). These credentials are used to authenticate the backup transaction and to encrypt metadata defining authorized tenants or identity groups permitted to perform subsequent restore operations. During a restore operation, including cross-cluster restores as illustrated in FIG. 6, the data-protection controller in the remote cluster decrypts the stored metadata using the credentials obtained from the corresponding AppVault Secret to validate whether the requesting tenant is authorized to restore the protected application. In this manner, the AppVault Secrets 355, 356 provide a secure linkage between the administrative namespace and the data-protection workflow, providing that credential handling and metadata encryption remain isolated from tenant namespaces while still enabling authenticated cross-cluster restore operations.

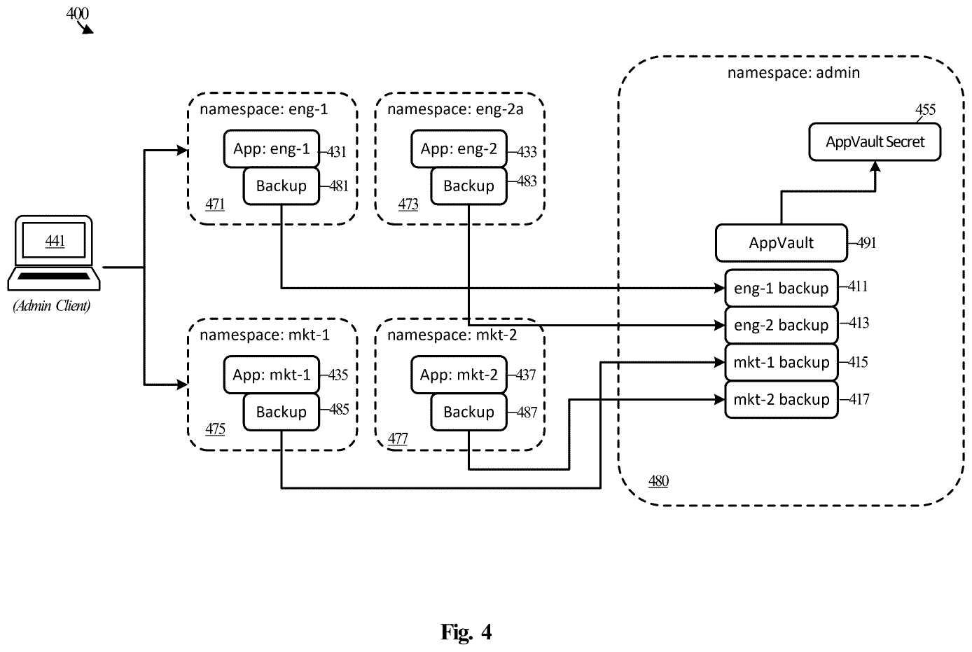

FIG. 4 illustrates namespace schema 400 according to some implementations. Namespace schema 400 includes admin client 441, application namespaces 471, 473, 475, and 477, and an administrative namespace 480. While namespace schema 400 shares similarities with namespace schema 300 of FIG. 3, FIG. 4 illustrates an alternative configuration in which a single AppVault 491 in administrative namespace 480 is shared across multiple tenant namespaces under centralized credential control. This configuration may be used in environments where storage access is consolidated under a unified administrative policy, such as a multi-department or multi-tenant environment utilizing a shared secured storage unit.

Admin client 441 has privileges to access all namespaces illustrated in FIG. 4, whereas the application namespaces 471, 473, 475, and 477 are associated with distinct tenants or tenant groups. Each application namespace includes an application custom resource (App: eng-1 431, App: eng-2 433, App: mkt-1 435, App: mkt-2 437) and a corresponding backup custom resource (Backup 481, 483, 485, 487). The backup custom resources are created by the respective tenants within their assigned namespaces to initiate backup operations for their applications. Each of these backup resources includes a reference field identifying the centralized AppVault 491 in administrative namespace 480, enabling the backup operation to utilize the shared secured storage configuration defined therein.

Administrative namespace 480 includes the centralized AppVault 491 and a corresponding AppVault Secret 455. The AppVault Secret 455 defines authentication credentials, access tokens, or encryption materials required to access the secured storage unit (e.g., a cloud bucket or storage system). The AppVault 491 references this Secret through a secure field, isolating sensitive credentials from tenant-accessible namespaces. The AppVault 491 further maintains metadata defining access control policies for tenants and namespaces permitted to reference it. In the example illustrated, AppVault 491 includes metadata authorizing backup resources 481, 483, 485, and 487, representing engineering and marketing tenants, to utilize the shared storage resource.

The backup references 411, 413, 415, 417 shown within administrative namespace 480 represent references in the backup resources to AppVault 491. These references are validated by data-protection controller 130 (see FIG. 1) during admission control operations, providing that each tenant has appropriate permissions to utilize the AppVault 491 based on its defined access metadata.

In general, namespace schema 400 illustrates that admin client 441 may configure AppVault resources 491 with a variety of access-control schemes to support both isolation (see FIG. 3) and controlled sharing (FIG. 4) across groups. Each AppVault may therefore specify distinct combinations of authorized roles, user groups, and namespaces, allowing organizations to implement fine-grained data-protection policies consistent with internal security requirements. By supporting such flexible configurations, the system enables administrators to partition or share storage resources according to business or operational needs while maintaining strong cross-namespace RBAC enforcement at the time of backup, restore, and snapshot operations.

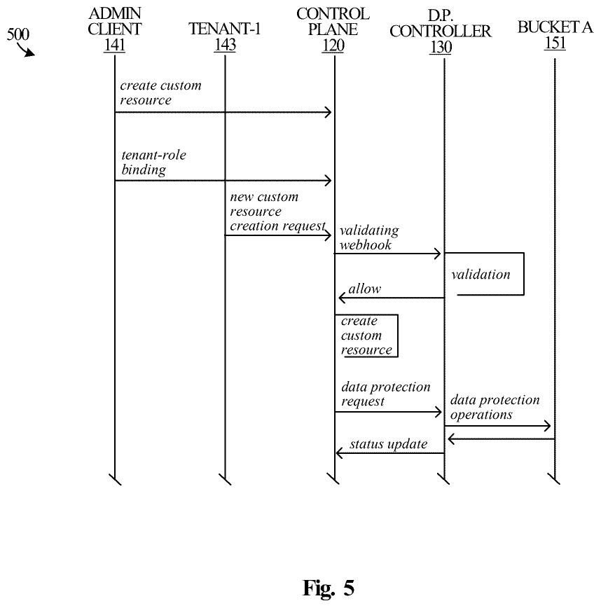

FIG. 5 illustrates an operation sequence in the context of compute environment 100 in an implementation, represented by sequence 500. Sequence 500 includes admin client 141, first tenant 143, control plane 120, data protection controller 130, and first bucket 151.

In sequence 500, admin client 141 first defines a custom resource, such as an AppVault, within control plane 120. This configuration process includes defining the custom resource in an administrative namespace and specifying metadata describing which tenants, namespaces, or roles are permitted to reference the resource from other custom resources residing in tenant namespaces. Admin client 141 also establishes tenant-role bindings within control plane 120 (for example, via RoleBindings or ClusterRoleBindings) to associate specific tenants with their corresponding namespaces and permissions. These tenant-role bindings may be created before or after the custom resource configuration in different implementations. For instance, first tenant 143 may be granted privileges across engineering namespaces, while another tenant may be limited to marketing namespaces.

After the configuration and bindings are established, tenant 143 submits a request to create a new custom resource within its namespace. The requested operation may represent, for example, a backup, restore, or snapshot creation referencing the administrative custom resource (such as the AppVault configured by admin client 141). Upon receiving the creation request, control plane 120 triggers a validating admission webhook to data-protection controller 130 for external validation. During the validation step, data-protection controller 130 verifies that the requesting tenant's effective roles and identity attributes satisfy the access metadata conditions defined in the referenced custom resource. If the tenant's permissions align with the authorized roles or groups indicated in the AppVault metadata, data protection controller 130 returns a positive admission determination (an “allow” determination) to control plane 120 as shown in FIG. 5; otherwise, the request is denied to prevent unauthorized cross-namespace references.

When data-protection controller 130 grants the admission request, control plane 120 proceeds to create and persist the corresponding custom resource (for example, storing the object in its key-value store). Following creation, control plane 120 issues a data-protection request to controller 130 to perform the associated operation, such as backing up application data, restoring an existing workload, or generating a snapshot. Controller 130 executes the requested data-protection process and stores or retrieves data from bucket 151, depending on the operation. Upon completion, data-protection controller 130 transmits a status update to control plane 120, upon which control plane 120 updates the state and metadata of the custom resource (in the key-value store) to reflect successful or failed completion of the operation. Sequence 500 thus demonstrates the end-to-end lifecycle of a cross-namespace custom-resource request.

FIG. 6 illustrates an example of a process for RBAC in a compute cluster, represented by process 600. Process 600 is performed by one or more computing devices which may be represented by computing system 801 of FIG. 8. The steps described by process 600 may be performed by components of compute environment 100, including control plane 120 data protection controller 130, and remote cluster 190. Process 600 may be implemented in program instructions (software and/or firmware) by one or more processors of the computing device(s). The program instructions direct the computing device to operate as follows, referring to the steps in FIG. 6.

Data protection controller 130 performs a backup operation for an application 135 in compute cluster 110 (step 601). This backup operation may be initiated in response to a backup custom resource admitted by control plane 120, as described in connection with FIGS. 1 and 2. The data protection controller 130 executes the backup by copying application data, configuration information, and persistent volume contents to a designated secured storage unit, such as bucket 151 or 155 defined by a referenced AppVault custom resource.

During the backup operation, data protection controller 130 encrypts metadata defining tenants authorized to restore the backup from the secured storage unit (step 603). The metadata may include one or more identity attributes associated with authorized tenants, such as group memberships, user identifiers, or service account identifiers. Data protection controller 130 may encrypt the metadata using a cryptographic key associated with the administrative namespace or AppVault configuration, and store the encrypted metadata in association with the backup data or as metadata within the AppVault custom resource, providing that only authorized components can later decrypt and interpret the access information.

Remote cluster 190 initiates a restore operation to restore the application in the remote cluster (step 605). The restore operation may be initiated by a tenant of the remote compute cluster through the creation of a restore custom resource referencing the secured storage unit containing the backup. In some embodiments, the control plane of the remote cluster 190 transmits a validating admission request to a local data protection controller of remote cluster 190 to determine whether the tenant is permitted to perform the restore.

Remote cluster 190 (e.g., a data protection controller of remote cluster 190) decrypts the encrypted metadata to determine whether the restore operation is allowed (step 607). The controller may retrieve the encrypted metadata from the secured storage unit or from the associated AppVault configuration, and decrypt the metadata using a corresponding key accessible only to administrative components. The decrypted metadata reveals the authorized identity attributes of tenants that may perform restores for the protected backup.

Remote cluster 190 (e.g., a data protection controller of the remote cluster) compares the identity attributes of the requesting tenant with the decrypted metadata to determine whether the restore operation is permitted (step 609). When the tenant identity does not match any of the authorized entries, the controller denies the restore operation and transmits the denial to the control plane of the remote compute cluster (step 611). The control plane may reject the restore custom resource and generate an audit event recording the unauthorized attempt.

When the identity attributes of the requesting tenant match those specified in the decrypted metadata, the remote cluster 190 (e.g., a data protection controller of the remote cluster) performs the restore operation (step 613). Performing the restore operation may include retrieving the backup data from the secured storage unit (e.g., bucket 151 or 155), reconstructing application configuration, and restoring persistent volumes within the tenant's namespace of the remote compute cluster.

Through these operations, process 600 facilitates secure and identity-aware restoration of application backups across clusters, ensuring that only authorized tenants defined at backup time can initiate restore operations. Process 600 illustrates an extension the role-based access control mechanisms to cross-cluster backup and restore scenarios, thereby maintaining tenant isolation and data security across distributed environments.

FIG. 7 illustrates compute cluster 700 in an implementation. Compute cluster 700 includes control plane 710 and compute nodes 750. Compute cluster 700 may be a Kubernetes cluster; however, compute cluster 700 may also be representative of various other orchestration platforms. Compute cluster 700 may be representative of compute cluster 110 of FIG. 1.

Control plane 710 is representative of a software service that manages resources in compute cluster 700, and may, for example, be a Kubernetes control plane. Control plane 710 can operate from one or more nodes or virtual machines within compute cluster 700. Control plane 710 includes API server 720, controller manager 730, key-value store 735, and scheduler 740.

API server 720 is a central interface in control plane 710 for processing and validating requests. API server 720 is in communication with compute nodes 750, controller manager 730, key-value store 735, scheduler 740, as well as external clients such as a node management service as described herein. API server 720 processes requests (such as requests to create, update, or delete resources), validates them, and updates the state of compute cluster 700 in key-value store 735. API server 720 may also handle authentication and authorization of client requests, ensuring that only permitted users and services can access or modify cluster resources. API server 720 is configured (e.g., by admin client 141 of FIG. 1) to intercept requests and forward requests via a webhook (e.g., validating requests from control plane 120 to data protection controller 130 of FIG. 1, as described herein).

Controller manager 730 is representative of a service that manages controllers to maintain the state of compute cluster 700 by continuously monitoring the current state and reconciling the current state with the desired state as defined in key-value store 735. Controller manager 730 orchestrates tasks to achieve the desired state, such as coordinating the creation or deletion of pods to match the specified number of pod replicas, monitoring the health of compute nodes 750, and initiating replacement or recovery actions for failed nodes.

Key-value store 735, which may be Kubernetes etcd in some implementations, maintains the cluster's configuration data and state information. Key-value store 735 is configured to store role-bindings, for example the tenant role-bindings used for RBAC control as described herein.

Scheduler 740 assigns workloads such as pods to appropriate compute nodes 750. Scheduler 740 makes scheduling decisions based on resource availability, constraints, and policies.

Compute nodes 750 are representative of virtual machines or physical servers on which workloads run. While three compute nodes 750 are shown in FIG. 7 for clarity, it is noted that compute cluster 700 may include any number of compute nodes. Compute nodes 750 include pods 759 and node agent 757.

Pods 759 are representative of native resources of compute cluster 700 that host containerized applications in compute cluster. These containerized applications may include, for example, containerized applications running data protection controller 130 and applications 135 of FIG. 1.

Node agent 757 (e.g., Kubelet) is representative of a service running on compute node 750 that manages the state of pods on compute node 750. Node agent 757 communicates with API server 720 to receive instructions about which pods to run. Node agent 757 performs tasks such as starting, stopping, and managing containerized workloads. Additionally, node agent 757 monitors running pods containers, collects resource usage metrics, and reports on the state of compute node 750 to control plane 710.

FIG. 8 illustrates computing system 801, which is representative of any system or collection of systems in which the various applications, processes, services, and scenarios disclosed herein may be implemented. Examples of computing system 801 include, but are not limited to server computers, web servers, cloud computing platforms, and data center equipment, as well as any other type of physical or virtual server machine, container, and any variation or combination thereof. (In some examples, computing system 801 may also be representative of desktop and laptop computers, tablet computers, and the like.)

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements role-based access processes 806, which is representative of the processes discussed with respect to the preceding Figures, such as processes 200 and 600. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may include a microprocessor and other circuitry that retrieves and executes software 805 from storage system 803. Processing system multiple processing devices or sub-systems that cooperate in executing program instructions. Examples of processing system 802 include general purpose central processing units, microcontroller units, graphical processing units, application specific processors, integrated circuits, application specific integrated circuits, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 803 may be implemented as a single storage device but may also be implemented across multiple storage devices or sub-systems co-located or distributed relative to each other. Storage system 803 may comprise additional elements, such as a controller capable of communicating with processing system 802 or possibly other systems.

Software 805 (including role-based access processes 806) may be implemented in program instructions and among other functions may, when executed by processing system 802, direct processing system 802 to operate as described with respect to the various operational scenarios, sequences, and processes illustrated herein. For example, software 805 may include program instructions for implementing role-based access control procedures described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

What is claimed is:

1. A computer-implemented method for data protection in a compute cluster, comprising:
receiving, by a control plane of the compute cluster, a custom-resource request from a tenant to create or modify a first custom resource in a tenant namespace, the first custom resource comprising a reference to a second custom resource in an administrative namespace;
transmitting, by the control plane in response to the custom-resource request, a validating admission request to a data protection controller registered with the control plane for admission validation;
retrieving, by the data protection controller, access metadata defined in the second custom resource;
generating, by the data protection controller based at least on the access metadata, an admission determination indicating whether the custom-resource request is permitted; and
providing, by the data protection controller, the admission determination to the control plane, thus providing for access enforcement across namespaces at a time of creation or modification of custom-resources.

2. The computer-implemented method of claim 1, wherein:
the data protection controller is registered with the control plane as a webhook endpoint, the control plane is configured to trigger a webhook based on custom-resource requests for creation or modification of custom resources, and the validating admission request is transmitted via the webhook to the webhook endpoint.

3. The computer-implemented method of claim 1, wherein:
the validating admission request includes one or more identity attributes of the tenant comprising one or more of:
a group membership, or a service account identifier; and
the data protection controller generates the admission determination by comparing the identity attributes of the tenant with access metadata defined for a referenced second custom resource to determine whether the tenant satisfies access conditions specified in the access metadata.

4. The computer-implemented method of claim 3, wherein the access metadata further defines authorized roles permitted to reference the second custom resource; and
the data protection controller further generates the admission determination by determining roles associated with the tenant based on the one or more identity attributes and comparing the determined roles with the authorized roles.

5. The computer-implemented method of claim 1, further comprising:
storing, by the data protection controller, the admission determination in a decision cache for subsequent access determinations.

6. The computer-implemented method of claim 1, wherein the second custom resource defines configuration parameters for a secured storage unit.

7. The computer-implemented method of claim 6, wherein the first custom resource is a backup custom resource, wherein the backup custom resource initiates a backup of an application in the compute cluster to the secured storage unit referenced by the second custom resource.

8. The computer-implemented method of claim 7, further comprising:
performing, by the data protection controller, a backup operation to back up the application in the secured storage unit in response to the admission determination permitting the custom-resource request;
encrypting, by the data protection controller, metadata defining one or more identity attributes of tenants authorized to restore the backup; and
storing the encrypted metadata in association with the secured storage unit.

9. The computer-implemented method of claim 8, further comprising:
initiating, by a second compute cluster, a restore operation to restore the application from the secured storage unit;
decrypting, by the second compute cluster, the encrypted metadata to obtain one or more identity attributes of tenants authorized to perform the restore; and
determining, by the second compute cluster, whether to permit the restore operation based at least on the decrypted identity attributes.

10. The computer-implemented method of claim 6, wherein the first custom resource comprises one of:
a backup custom resource initiating backup of an application in the compute cluster;
a restore custom resource initiating a restore operation for an application in the compute cluster; or a snapshot custom resource initiating a snapshot of an application in the compute cluster.

11. The computer-implemented method of claim 1, wherein:
the first custom resource comprises a restore custom resource that specifies a restore of an application in the compute cluster, and the generating the admission determination is further based on a determination whether the tenant has permission to update an application custom resource associated with the application.

12. The computer-implemented method of claim 1, wherein the control plane is configured with a fail-closed admission policy such that, upon unavailability of the data protection controller, the custom-resource requests are automatically denied.

13. A system for data protection in a compute cluster, comprising:
a control plane configured to:
receive a custom-resource request from a tenant to create or modify a first custom resource in a tenant namespace, the first custom resource comprising a reference to a second custom resource in an administrative namespace; and
transmit, in response to the custom-resource request, a validating admission request to a data-protection controller registered with the control plane for admission validation; and
a data-protection controller configured to:
retrieve access metadata defined in the second custom resource;
generate, based at least on the access metadata, an admission determination indicating whether the custom-resource request is permitted; and
provide the admission determination to the control plane.

14. The system of claim 13, wherein:
the data-protection controller is registered with the control plane as a webhook endpoint,
the control plane is configured to trigger a webhook based on custom-resource requests for creation or modification of custom resources, and
the validating admission request is transmitted via the webhook to the webhook endpoint.

15. The system of claim 13, wherein:
the validating admission request includes one or more identity attributes of the tenant comprising one or more of:
a group membership, or
a service account identifier; and
the data-protection controller is further configured to generate the admission determination by comparing the identity attributes of the tenant with access metadata defined for the second custom resource to determine whether the tenant satisfies access conditions specified in the access metadata.

16. The system of claim 15, wherein:
the access metadata defines authorized roles permitted to reference the second custom resource, and
the data-protection controller is further configured to determine roles associated with the tenant based on the one or more identity attributes and to compare the determined roles with the authorized roles.

17. The system of claim 13, wherein the data-protection controller is further configured to store the admission determination in a decision cache for subsequent access determinations.

18. The system of claim 13, wherein the control plane is configured with a fail-closed admission policy such that, upon unavailability or timeout of the data-protection controller, the control plane automatically denies custom-resource requests to preserve cluster security integrity.

19. A computer-implemented method for operating a data protection controller running in a Kubernetes cluster, comprising:
obtaining, at the data protection controller and from a Kubernetes control plane, a validating admission request to validate a custom resource operation on a first custom resource;
retrieving, by the data protection controller, access metadata defined in a second custom resource referenced by the first custom resource; and
providing, by the data protection controller, a grant or denial of the custom resource operation based at least on the access metadata.

20. The computer-implemented method of claim 19, wherein:
the data protection controller is registered with the Kubernetes control plane as a webhook endpoint,
the Kubernetes control plane is configured to trigger a webhook based on custom-resource requests for creation or modification of custom resources, and
the validating admission request is transmitted via the webhook to the webhook endpoint.
